(19) United States
(12) Patent Application Publication
(10) Pub. No.: US 2017/0365935 A1
(43) Pub. Date: Dec. 21, 2017

(54) ARRAY ANTENNA

(71) Applicant: Panasonic Intellectual Property Management Co., Ltd., Osaka (JP)

(72) Inventors: YUICHI KASHINO, Ishikawa (JP); RYOSUKE SHIOZAKI, Tokyo (JP); KEN TAKAHASHI, Ishikawa (JP)

(21) Appl. No.: 15/617,685

(22) Filed: Jun. 8, 2017

(30) Foreign Application Priority Data
Jun. 16, 2016 (JP) 2016-119762

(51) Int. Cl. H01Q 21/22; H01Q 3/34; H01Q 21/00; H01Q 25/00; H01Q 21/06

(52) U.S. Cl. CPC H01Q 21/22; H01Q 21/0075; H01Q 25/00; H01Q 3/34; H01Q 21/065; H01Q 21/064

(57) ABSTRACT

An array antenna includes a dielectric substrate, and a plurality of radiating elements being arranged linearly and provided on a first face of the dielectric substrate, each of the plurality of radiating elements having linear polarization and a rotation reference point, wherein one or more radiating elements included in the plurality of radiating elements are rotated differently with respect to the corresponding rotation reference positions each other.

### BACKGROUND

### 1. Technical Field

The present disclosure relates to array antennas that irradiate radio waves.

### 2. Description of the Related Art

Known array antennas of related art include the array antenna discussed in Japanese Unexamined Patent Application Publication No. 4-37204. FIG. 14 illustrates the configuration of the array antenna disclosed in Japanese Unexamined Patent Application Publication No. 4-37204.

The array antenna illustrated in FIG. 14 is a microstrip array antenna where patch antennas and strip conductors are formed on a dielectric substrate 2 with the back face on which a conductor ground plate 1 is formed. The power input from a feeding portion 3 is radiated from each of radiating elements 5 through microstrip lines 4 arranged on the dielectric substrate 2.

In the array antenna illustrated in Japanese Unexamined Patent Application Publication No. 4-37204, as illustrated in FIG. 14, columns A, B, and C are different in number of elements in the Y direction and the number of elements in column A in an end portion of the substrate is smaller than the number of elements in column C in a central portion of the substrate. This configuration enables the gain of a column in an end portion of the substrate to be lower than the gain of a column in a central portion of the substrate and can inhibit unwanted radiation (the side lobe level).

Since in the related-art techniques of Japanese Unexamined Patent Application Publication No. 4-37204 described above, however, the numbers of elements differ among columns and besides, coupling conditions between adjacent elements differ among columns, feeding lines need to be designed for individual columns and this hinders designing of an array antenna.

### SUMMARY

One non-limiting and exemplary embodiment facilitates providing an array antenna where side lobes of radiated radio waves can be controlled with a simple feeding line configuration.

In one general aspect, the techniques disclosed here feature an array antenna that includes a dielectric substrate, and a plurality of radiating elements being arranged linearly and provided on a first face of the dielectric substrate, each of the plurality of radiating elements having linear polarization and a rotation reference point, wherein one or more radiating elements included in the plurality of radiating elements are rotated differently with respect to the corresponding rotation reference positions each other.

The present disclosure contributes to control of side lobes of radiated radio waves with a simple feeding line configuration.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a front view that illustrates an array antenna according to a first embodiment;

FIG. 2 is a II-II cross-sectional view of the array antenna according to the first embodiment;

FIG. 3 illustrates a change calculation model of gain with respect to a rotation angle of a radiating element;

FIG. 4 illustrates change characteristics of the gain with respect to the rotation angle of the radiating element;

FIG. 5 illustrates gain distribution of columns according to the first embodiment;

FIG. 6 illustrates an XZ-plane radiation pattern according to the first embodiment;

FIG. 7 is a front view that illustrates an array antenna according to a second embodiment;

FIG. 8 is a front view that illustrates an array antenna according to a third embodiment;

FIG. 9 is a front view that illustrates an array antenna according to a fourth embodiment;

FIG. 10 illustrates an example of a configuration of a loop array antenna according to the fourth embodiment;

FIG. 11 illustrates an example of a configuration of a microstrip comb-line antenna according to the fourth embodiment;

FIG. 12 illustrates an example of a configuration of a slot array antenna according to the fourth embodiment;

FIG. 13 is a front view that illustrates an array antenna according to a fifth embodiment; and

FIG. 14 is a perspective view that illustrates an array antenna of related art.

### DETAILED DESCRIPTION

### Embodiments

A radar device employing an array antenna and installed in a vehicle is described below.

Radio waves radiated from directional antennas of a typical array antenna, for example, include side lobes oriented in directions shifted from a desired direction in addition to the main lobe oriented in the desired direction.

A radar device installed in a vehicle causes the main lobe to be oriented in a desired direction so as to detect an object in the desired direction. When the radar device radiates radio waves that include large side lobes, however, false detection is caused under the influence of the side lobes as if there would be an object in the desired direction even without any object in the desired direction.

An array antenna radiating radio waves whose side lobes can be controlled by changing the polarization directions of a plurality of arrayed radiating elements on a column-by-column basis is described below.

Embodiments of the present disclosure are described below with reference to the drawings. In each embodiment, identical references are given to the constituents having identical functions and the overlapping descriptions are omitted. All the figures mentioned below schematically illustrate configurations and the dimensions of each element are exaggerated in the illustrations for simplification of descriptions while some elements are omitted in the illustrations where appropriate. The embodiments described below are examples and are not intended to limit the present disclosure.

### First Embodiment

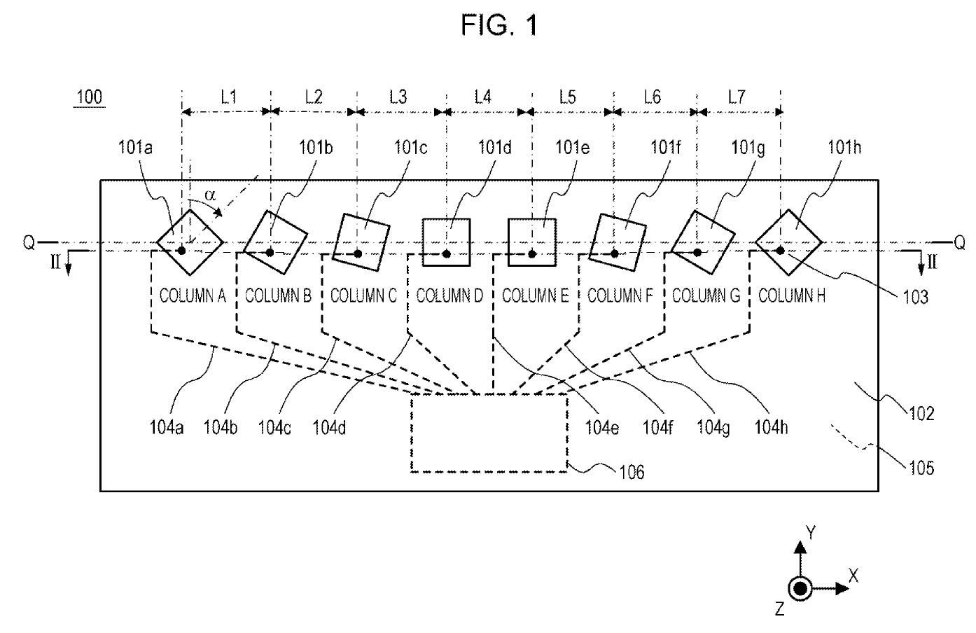

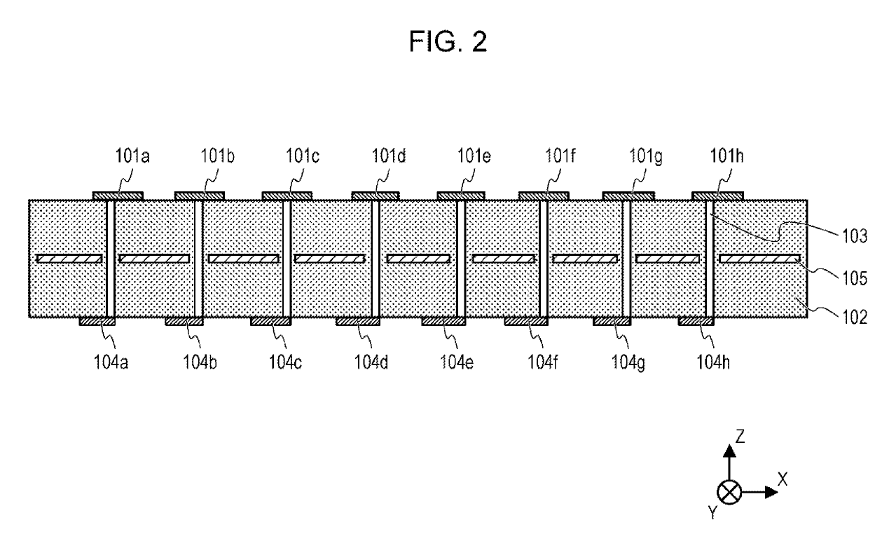

FIG. 1 is a plan view that illustrates a configuration of a planar array antenna 100 according to a first embodiment of the present disclosure. FIG. 2 is a cross-sectional view along II-II in FIG. 1. In the description below, the lateral direction in FIG. 1 is referred to as the X direction and specifically, the rightward direction is referred to as the +X direction while the leftward direction is referred to as the −X direction. Further, the orthogonal direction to the X direction in FIG. 1 is referred to as the Y direction and specifically, the upward direction is referred to as the +Y direction while the downward direction is referred to as the −Y direction. Also in the description below, the spatial depth direction in FIG. 1 is referred to as the Z direction and specifically, the spatially forward direction is referred to as the +Z direction while the spatially backward direction is referred to as the −Z direction.

As illustrated in FIG. 1, the planar array antenna 100 is a patch array antenna for example, which includes radiating elements 101a to 101h, a dielectric substrate 102, feeding vias 103, feeding lines 104a to 104h, a ground plate 105, and a radio unit 106.

As illustrated in FIGS. 1 and 2, the radiating elements 101a to 101h are arranged so that, on the dielectric substrate 102 shaped like a flat plate, the central positions of the radiating elements 101a to 101 h agree in the Y direction and are aligned at regular intervals in the X direction. That is, the radiating elements 101a to 101h are arranged so that the centers of the radiating elements 101a to 101h are linearly located by performing rotation by predetermined angles while the central positions of the radiating elements 101a to 101h serve as the centers of the rotation. The radiating elements 101a to 101h are square patch antennas and radiate radio waves of linear polarization.

The radiating elements 101a, 101b, 101c, 101d, 101e, 101f, 101g, and 101h are positioned sequentially from the negative direction of the X axis to the positive direction of the X axis. Also, the radiating element 101a is positioned in column A, the radiating element 101b is positioned in column B, the radiating element 101c is positioned in column C, the radiating element 101d is positioned in column D, the radiating element 101e is positioned in column E, the radiating element 101f is positioned in column F, the radiating element 101g is positioned in column G, and the radiating element 101h is positioned in column H.

In FIG. 1, the alternate long and short dashed lines indicated by Q-Q denote the straight line that connects the central positions of the radiating elements 101a to 101h in the Y direction. Because of such an arrangement, the positions of feeding ports of the feeding vias 103 through which power is fed to the radiating elements 101a to 101h are different from each other in the Y direction and are spaced from each other at non-regular intervals in the X direction.

The distance between the feeding via 103 of the radiating element 101a and the feeding via 103 of the radiating element 101b is L1, the distance between the feeding via 103 of the radiating element 101b and the feeding via 103 of the radiating element 101c is L2, the distance between the feeding via 103 of the radiating element 101c and the feeding via 103 of the radiating element 101d is L3, the distance between the feeding via 103 of the radiating element 101d and the feeding via 103 of the radiating element 101e is L4, the distance between the feeding via 103 of the radiating element 101e and the feeding via 103 of the radiating element 101f is L5, the distance between the feeding via 103 of the radiating element 101f and the feeding via 103 of the radiating element 101g is L6, and the distance between the feeding via 103 of the radiating element 101g and the feeding via 103 of the radiating element 101h is L7. The distances L1 to L7 have values different from each other for example.

As illustrated in FIG. 2, the outside of each feeding via 103 is metal for example, and the feeding vias 103 are provided so as to correspond to the respective radiating elements 101a to 101h and pass through the dielectric substrate 102 in the Z direction. End portions of the feeding vias 103 in the +Z direction are coupled to the corresponding radiating elements 101a to 101h and the other end portions of the feeding vias 103 in the −Z direction are coupled to the corresponding feeding lines 104a to 104h. Each feeding via 103 may be hollow or be filled with a filling material.

As illustrated in FIGS. 1 and 2, in the dielectric substrate 102, the feeding lines 104a to 104h are arranged on the back face, which is opposite the face where the radiating elements 101a to 101h are arranged. The radio unit 106 is mounted on the same face as that where the feeding lines 104a to 104h are arranged. The feeding lines 104a to 104h are configured as a copper foil pattern formed by etching for example. The feeding lines 104a to 104h are each coupled to the radio unit 106. The output power from the radio unit 106 is fed to the radiating elements 101a to 101h through the feeding lines 104a to 104h and the feeding vias 103.

As illustrated in FIG. 2, the ground plate 105 is arranged in the dielectric substrate 102 lying in the −Z direction relative to the radiating elements 101a to 101h and functions as a reflector. In FIG. 2, the ground plate 105 is separated but coupled in other portions.

The radiating elements 101a to 101h function as an array antenna and form beams. Thus, by regulating the phase of the output power from the radio unit 106 to the feeding lines 104a to 104h by known techniques, the direction of the directivity can be regulated. In the present embodiment, the main polarization direction of the radio system that uses the planar array antenna 100 is in the +Y direction.

In the present embodiment, as illustrated in FIG. 1, when a represents the rotation angle for each of the radiating elements 101a to 101h in the +X direction relative to the +Y direction, the rotation angles α for the radiating elements 101d and 101e in columns D and E are each 0 degrees, the rotation angles α for the radiating elements 101c and 101f in columns C and F are each 15 degrees, the rotation angles α for the radiating elements 101b and 101g in columns B and G are each 30 degrees, and the rotation angles α for the radiating elements 101a and 101h in columns A and H are each 45 degrees.

That is, the deviation of the polarization direction of the radiating element 101c with the rotation angle α of 15 degrees from the +Y direction is larger than the deviation of the radiating element 101d with the rotation angle α of 0 degrees, which is adjacent to the radiating element 101c in a portion dose to the center of the planar array antenna 100, from the +Y direction.

Similarly, the deviation of the polarization direction of the radiating element 101b with the rotation angle α of 30 degrees from the +Y direction is larger than the deviation of the radiating element 101c with the rotation angle α of 15 degrees from the +Y direction. Further, the deviation of the polarization direction of the radiating element 101a with the rotation angle α of 45 degrees from the +Y direction is larger than the deviation of the radiating element 101b with the rotation angle α of 30 degrees from the +Y direction.

Moreover, the deviation of the polarization direction of the radiating element 101f with the rotation angle α of 15 degrees from the +Y direction is larger than the deviation of the radiating element 101e with the rotation angle α of 0 degrees, which is adjacent to the radiating element 101f in a portion close to the center of the planar array antenna 100, from the +Y direction.

Similarly, the deviation of the polarization direction of the radiating element 101g with the rotation angle α of 30 degrees from the +Y direction is larger than the deviation of the radiating element 101f with the rotation angle α of 15 degrees from the +Y direction. Further, the deviation of the polarization direction of the radiating element 101h with the rotation angle α of 45 degrees from the +Y direction is larger than the deviation of the radiating element 101g with the rotation angle α of 30 degrees from the +Y direction.

By changing the rotation angles of radiating elements on a column-by-column basis in this manner, the main polarization direction of each radiating element is changed and the planar array antenna 100 attains two or more polarization directions.

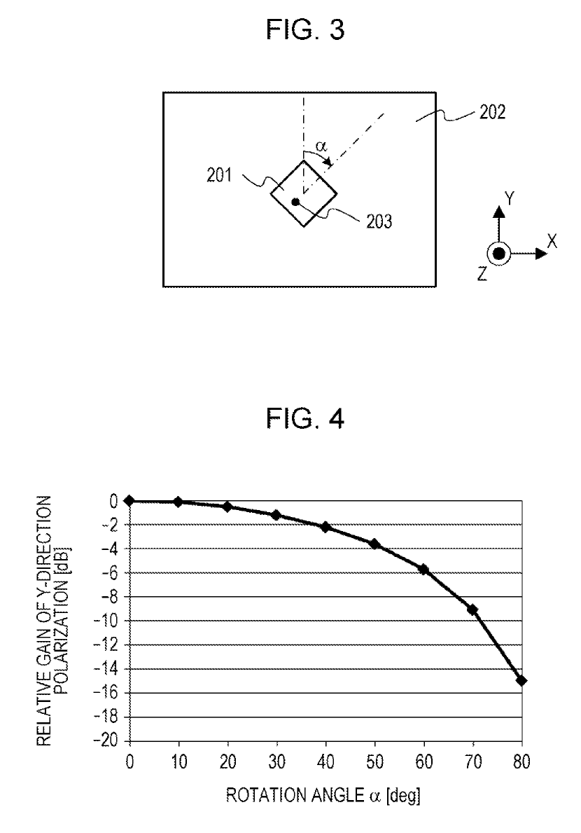

Described below using an example of a model of a single patch antenna illustrated in FIG. 3 is the relation between the rotation angle α of a radiating element based on the central position of the radiating element and gain in the +Z direction.

The example of the single patch antenna model illustrated in FIG. 3 includes a radiating element 201, a dielectric substrate 202, and a feeding port 203. The dielectric substrate 202 has a dielectric constant of 3.4 and a thickness of 0.25 mm.

FIG. 4 illustrates gain of Y-direction polarization in a case where, in the single patch antenna model depicted in FIG. 3, the radiating element 201 is rotated by the angle α in the +X direction from the +Y direction on the basis of the center of the radiating element 201. The horizontal axis in FIG. 4 indicates the rotation angle α of the radiating element 201 and the vertical axis in FIG. 4 indicates relative gain of the Y-direction polarization.

In FIG. 4, the vertical axis indicates the relative gain obtained by standardizing the gain at the rotation angle α of 0 degrees as 0 dB. As illustrated in FIG. 4, the gain of the Y-direction polarization is highest when the rotation angle α is 0 degrees, and as the rotation angle α changes from 0 degrees toward 90 degrees, the polarization loss increases and the gain decreases accordingly.

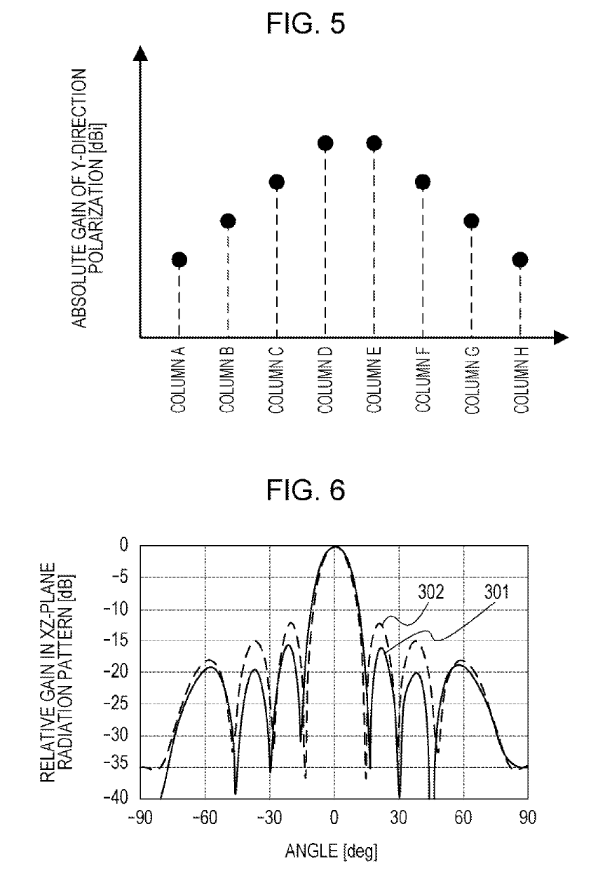

FIG. 5 illustrates gain distribution of the Y-direction polarization in the planar array antenna 100 where the rotation angles α for the radiating elements 101a to 101h are changed on the basis of the columns illustrated in FIG. 1 by utilizing the change in the Y-direction polarization with respect to the rotation angle α of a radiating element, such as that demonstrated in FIG. 4. In FIG. 5, the horizontal axis indicates columns A to H and the vertical axis indicates absolute gain of the Y-direction polarization. Since the gain distribution illustrated in FIG. 5 exhibits the Taylor distribution, side lobes in an XZ-plane radiation pattern of the planar array antenna 100 can be reduced.

FIG. 6 illustrates XZ-plane radiation patterns of planar array antennas. In FIG. 6, the horizontal axis indicates an angle. In FIG. 6, the vertical axis indicates relative gain obtained by standardizing the maximum gain of a planar array antenna as 0 dB. A radiation pattern 301, which is indicated by a solid line in FIG. 6, is a radiation pattern of the planar array antenna 100 according to the present embodiment. For comparison, a radiation pattern 302 of a planar array antenna where the rotation angles α for the radiating elements in all columns are 0 degrees is indicated by a broken line. In both the radiation patterns 301 and 302, all the radiating elements are excited in phase.

As illustrated in FIG. 6, it can be observed that in the radiation pattern 301 using the techniques of the present disclosure, all the side lobes other than the main lobe are reduced more successfully than in the radiation pattern 302. Particularly, it can be observed that the side lobes close to the main lobe, which become one of the causes of false detection in a radar device that employs a planar array antenna, are largely reduced.

Thus, according to the present disclosure, by rotating the polarization directions of the radiating elements 101a, 101b, 101c, 101f, 101g, and 101h, which are arrayed in array end portions of the planar array antenna 100, relative to the polarization directions of the radiating elements 101d and 101e, which agree with the main polarization direction of the radio system that uses the planar array antenna 100, the Taylor distribution illustrated in FIG. 5 can be achieved and the side lobes can be reduced. In addition, as illustrated in FIG. 1, the pattern shapes of the feeding lines 104a to 104h in the respective columns can be simplified and feeding lines can be therefore formed with a simple configuration.

Although in the present embodiment illustrated in FIG. 1, the radiating elements with the polarization directions that agree with the main polarization direction of the radio system that uses the planar array antenna 100 (i.e. the +Y direction) are arrayed in two columns dose to an array central portion, which are columns D and E, the arrangement is not limited thereto. For example, the radiating elements with the polarization directions that are in the +Y direction may be arranged in two columns that are columns C and D or may be arranged in two columns that are columns A and B.

Although in the present embodiment illustrated in FIG. 1, the radiating elements 101a to 101 h are arranged so that the central positions of the radiating elements 101a to 101h are spaced at regular intervals in the X direction, the arrangement is not limited thereto. For example, adjacent radiating elements may be arranged so that the central positions of the radiating elements are spaced at non-regular intervals in the X direction.

Although in the present embodiment illustrated in FIG. 1, the polarization directions of the radiating elements 101d and 101e agree with the main polarization direction of the radio system (i.e. the +Y direction), the arrangement is not limited thereto. As long as the polarization directions of the radiating elements 101d and 101e are close to the +Y direction, similar advantages can be obtained.

Although in the present embodiment illustrated in FIG. 1, the rotation angles α are increased as the distance from the radiating elements 101d and 101e becomes larger by setting the rotation angle α for the radiating elements 101c and 101f to 15 degrees, the rotation angle α for the radiating elements 101b and 101g to 30 degrees, and the rotation angle α for the radiating elements 101a and 101 h to 45 degrees, the rotation angle α for each radiating element is not limited thereto.

The rotation angles α for a plurality of adjacent radiating elements may be identical or the rotation angles for all the radiating elements other than the radiating elements with the polarization directions that are in the +Y direction may be identical predetermined angles larger than 0 degrees. Side lobes can be reduced by changing the rotation angles for the radiating elements other than the radiating elements with the polarization directions that are in the +Y direction.

Among adjacent radiating elements, the rotation angles for the radiating elements arranged closer to array end portions may be larger than the rotation angles for the radiating elements arranged closer to an array central portion. Accordingly, the Taylor distribution can be achieved as the gain distribution of columns and side lobes can be reduced more suitably.

### Second Embodiment

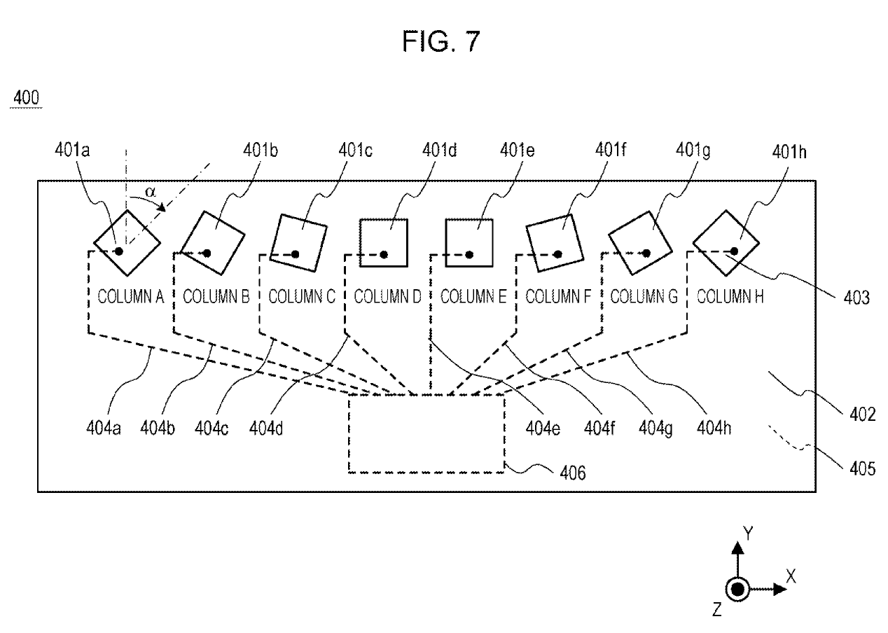

FIG. 7 is a plan view that illustrates a configuration of a planar array antenna 400 according to a second embodiment of the present disclosure. As illustrated in FIG. 7, the planar array antenna 400 includes radiating elements 401a to 401h arranged on a dielectric substrate 402, feeding vias 403 that pass through the dielectric substrate 402 in the Z direction, feeding lines 404a to 404h and a radio unit 406 arranged on the back face of the dielectric substrate 402, and a ground plate 405. Since the basic configuration of the planar array antenna 400 is similar to the configuration of the planar array antenna 100 according to the first embodiment, the description thereof may be omitted.

In the planar array antenna 100 according to the first embodiment, the rotation angle for the radiating element 101f is set to 15 degrees, which is equal to the rotation angle for the radiating element 101c, the rotation angle for the radiating element 101g is set to 30 degrees, which is equal to the rotation angle for the radiating element 101b, and the rotation angle for the radiating element 101h is set to 45 degrees, which is equal to the rotation angle for the radiating element 101a. In contrast, in the planar array antenna 400 according to the second embodiment, the direction in which the radiating elements 401f, 401g, and 401h are rotated is caused to be opposite the direction in which the radiating elements 401c, 401b, and 401a are rotated while the rotation angle for the radiating element 401f is set to −15 degrees, the rotation angle for the radiating element 401g is set to −30 degrees, and the rotation angle for the radiating element 401h is set to −45 degrees.

According to the second embodiment, the polarization directions of columns A and H, the polarization directions of columns B and G, and the polarization directions of columns C and F can each be mirror symmetric and it is thus facilitated to equalize the degrees of reduction in the side lobes that appear on both sides of the main lobe in an XZ-plane radiation pattern (see FIG. 6).

### Third Embodiment

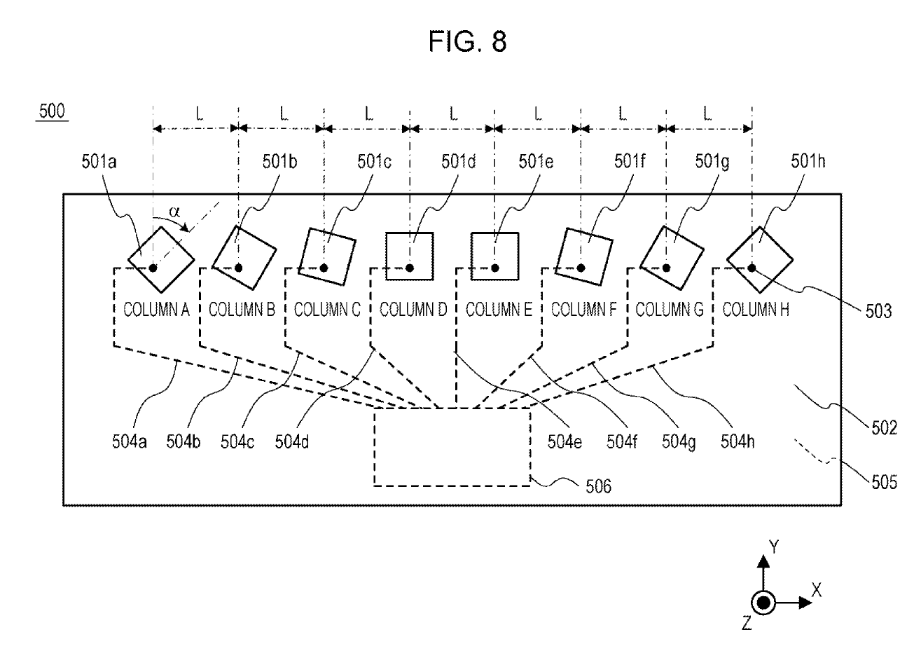

FIG. 8 is a plan view that illustrates a configuration of a planar array antenna 500 according to a third embodiment of the present disclosure. As illustrated in FIG. 8, the planar array antenna 500 includes radiating elements 501a to 501h arranged on a dielectric substrate 502, feeding vias 503 that pass through the dielectric substrate 502 in the Z direction, feeding lines 504a to 504h and a radio unit 506 arranged on the back face of the dielectric substrate 502, and a ground plate 505. As illustrated in FIG. 8, the feeding vias of adjacent radiating elements are each spaced by a distance L. Since the basic configuration of the planar array antenna 500 is similar to the configuration of the planar array antenna 100 according to the first embodiment, the description thereof may be omitted.

In the planar array antenna 100 according to the first embodiment, the radiating elements 101a to 101h are arranged so that the central positions of the radiating elements 101a to 101h agree in the Y direction and are aligned at regular intervals in the X direction.

In contrast, in the planar array antenna 500 according to the third embodiment, as illustrated in FIG. 8, the radiating elements 501a to 501h are arranged so that the positions of the feeding ports of the feeding vias 503 through which power is fed to the radiating elements 501a to 501h agree in the Y direction and are aligned at regular intervals in the X direction. That is, the radiating elements 501a to 501h are arranged so that the feeding positions for the radiating elements 501a to 501h are linearly located. Specifically, by being rotated by predetermined angles while the feeding ports each serve as the center of the rotation, the radiating elements 501a to 501h can be arranged so that the respective feeding vias of the radiating elements 501a to 501 h are positioned linearly and the radiating elements 501a to 501h adjacent to each other are each spaced by an identical distance.

According to the third embodiment, since the radiating elements are arranged so that the positions of the feeding ports of the feeding vias through which power is fed to the radiating elements agree in the Y direction and are aligned at regular intervals in the X direction, side lobes that appear on both sides of the main lobe in an XZ-plane radiation pattern (see FIG. 6) can be reduced.

Although in the description of the example above, the feeding ports of the radiating elements 501a to 501h are positioned so as to be aligned at regular intervals in the X direction, the arrangement is not limited thereto. The feeding ports for part of the adjacent radiating elements may be positioned so as to be arranged at non-regular intervals in the X direction. For example, at least one radiating element 501 may undergo horizontal displacement in the X-axis direction in addition to predetermined rotation.

### Fourth Embodiment

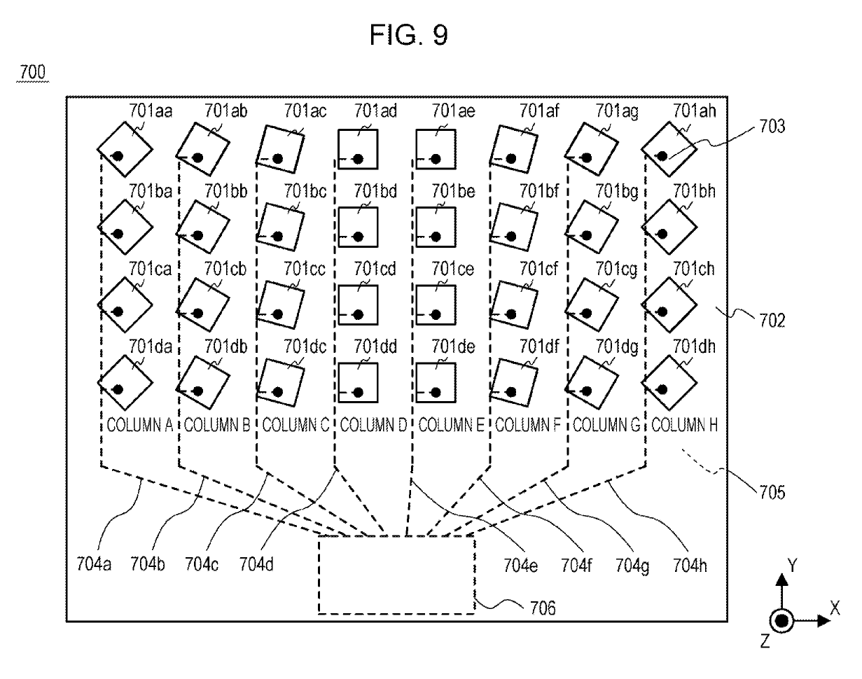

FIG. 9 is a plan view that illustrates a configuration of a planar array antenna 700 according to a fourth embodiment of the present disclosure. While the planar array antenna 100 according to the first embodiment is an array antenna where a plurality of radiating elements are arrayed in the X direction, the planar array antenna 700 according to the fourth embodiment is an array antenna where a plurality of radiating element groups in each of which a plurality of radiating elements are arrayed in the X direction are arrayed in the Y direction.

As illustrated in FIG. 9, the planar array antenna 700 includes radiating elements 701aa to 701dh arranged on a dielectric substrate 702, feeding vias 703 that pass through the dielectric substrate 702 in the Z direction, feeding lines 704a to 704h and a radio unit 706 arranged on the back face of the dielectric substrate 702, and a ground plate 705. Since the basic configuration of the planar array antenna 700 is similar to the configuration of the planar array antenna 100 according to the first embodiment, the description thereof may be omitted.

The feeding line 704a illustrated in FIG. 9 couples the radio unit 706 arranged near an end portion in the −Y direction on the back face of the dielectric substrate 702 and the radiating element 701aa arranged near an end portion in the +Y direction on the back face of the dielectric substrate 702, and is also coupled to the radiating elements 701ba, 701ca, and 701da by branching midway.

The radiating elements 701aa to 701ah (701ba to 701bh, 701ca to 701ch, and 701da to 701dh) are arranged so that the respective central positions of the radiating elements agree in the Y direction and are aligned at regular intervals in the X direction.

Further, the radiating elements 701aa to 701da are arranged so that the respective central positions of the radiating elements agree in the X direction and are aligned at regular intervals in the Y direction.

When in the planar array antenna 700, the wavelength of a radio wave radiated from the radiating elements 701aa to 701da is an effective wavelength λe that takes reduction in the wavelength of the dielectric substrate 702 into account, the radiating elements 701aa to 701da can be excited in phase by setting each interval between the radiating elements 701aa to 701da to λe.

Moreover, also in columns B to F, all the radiating elements arranged on the dielectric substrate 702 can be excited in phase by causing the shapes of the feeding lines to be identical. Accordingly, high gain can be obtained while reducing side lobes on an XZ-plane.

In addition, when a plurality of radiating elements are arrayed in the X direction and the Y direction, it is unnecessary to change the number of elements in the Y direction on a column-by-column basis and thus, variation in coupling conditions between adjacent radiating elements in each column in the array antenna can be inhibited and the configuration can be simplified.

Although in the description of the example illustrated in FIG. 9, the radiating elements arrayed in the Y direction are excited in phase, it is also possible to cause a phase difference between the radiating elements arrayed in the Y direction and tilt beams in the Y direction, and even in such a case, the advantages brought in the other embodiments can be obtained.

Moreover, although in the example illustrated in FIG. 9, the radiating elements arranged so as to be aligned in the X direction are arranged so that the respective central positions of the radiating elements agree in the Y direction and are spaced at regular intervals in the X direction, the arrangement is not limited thereto. For example, the radiating elements arranged so as to be aligned in the X direction may be arranged so that the positions of the respective feeding ports of the radiating elements agree in the Y direction and are spaced at regular intervals in the X direction.

### Variations of Fourth Embodiment

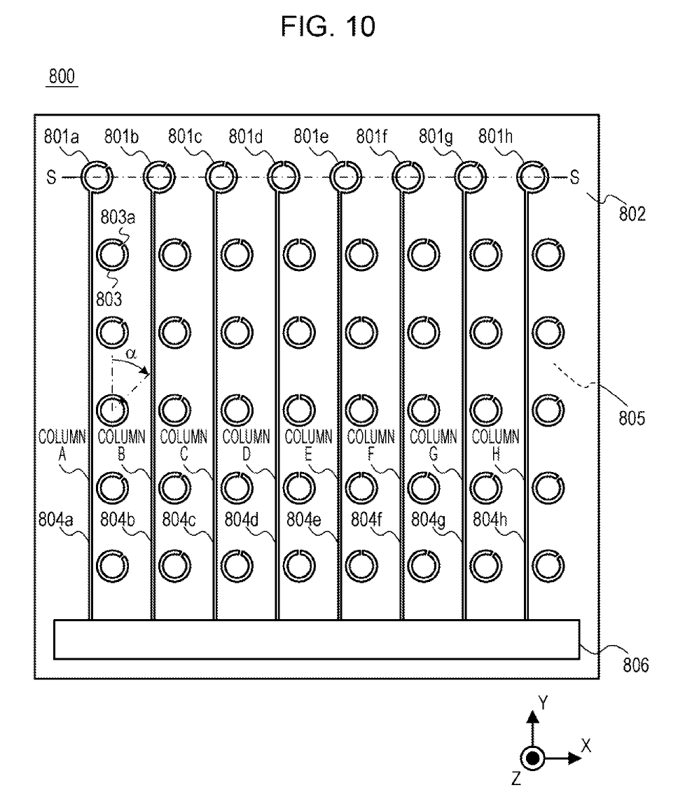

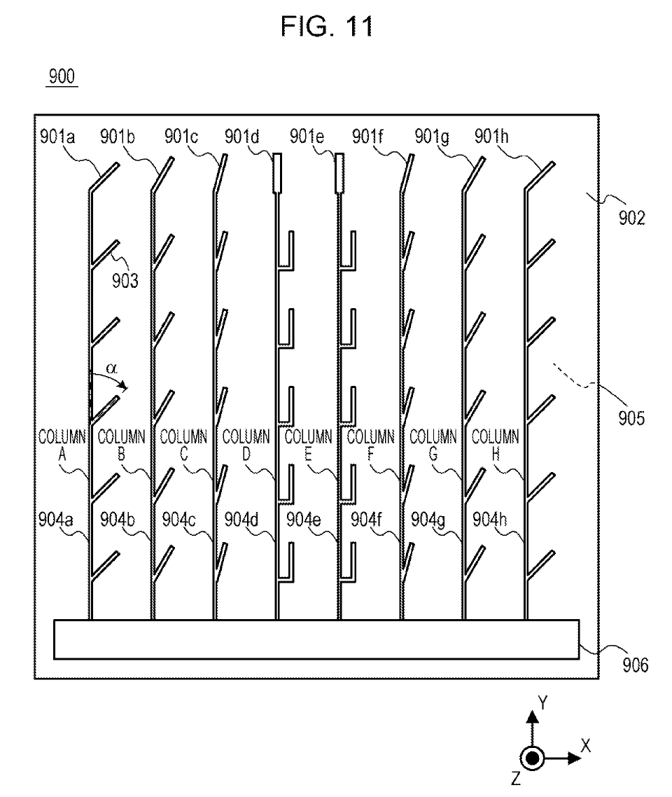

FIGS. 10 to 12 illustrates examples in which the radiating elements in the planar array antenna 700 according to the fourth embodiment of the present disclosure are implemented with radiating elements having other shapes. Since in each variation, the basic configuration is similar to the configuration of the planar array antenna 700 according to the fourth embodiment, the description thereof may be omitted.

FIG. 10 illustrates an example of a planar array antenna 800, where the radiating elements are configured using loop antennas. As illustrated in FIG. 10, a plurality of loop array antennas 801a to 801h where a plurality of loop elements 803 are arrayed in the Y direction are arrayed in the X direction on a dielectric substrate 802.

The loop array antennas 801a to 801h are constituted using the loop elements 803, which each have an element length of λe, and feeding lines 804a to 804h, and the loop elements 803 are fed with power from a radio unit 806 through the feeding lines 804a to 804h by electromagnetic coupling. Reference 805 indicates a ground plate.

The loop elements 803 arranged so as to be aligned in the X direction are arranged so that the respective central positions of the loop elements 803 agree in the Y direction and are aligned at regular intervals in the X direction. For example, in FIG. 10, the alternate long and short dashed lines indicated by S-S denote the straight line that connects the central positions of the radiating elements 801a to 801h in the Y direction. The loop elements may be arranged so that the central positions thereof are spaced at non-regular intervals in the X direction.

In part of each loop element 803, a cut portion 803a is formed and the position of the cut portion 803a determines the polarization direction. For example, since in the example illustrated in FIG. 10, the positions of the cut portions of the loop array antennas 801d and 801e in columns D and E are each in the +Y direction, the polarization directions thereof are each in the +Y direction.

In contrast, as for the loop array antennas 801a to 801c in columns A to C and the loop array antennas 801f to 801h in columns F to H, the positions of the cut portions are in the directions resulting from rotation from the +Y direction by the rotation angles α, and the polarization directions are also in the direction resulting from the rotation from the +Y direction by the rotation angles α.

Thus, according to the planar array antenna 800 illustrated in FIG. 10, side lobes in a radiation pattern of an XZ plane can be reduced by forming the cut portions 803a of the loop elements arrayed on end portion sides of the array antenna so that the cut portions 803a are in the directions resulting from the rotation from the main polarization direction of the radio system that uses the planar array antenna 800.

FIG. 11 illustrates an example of a planar array antenna 900, which employs a microstrip comb-line antenna for the configuration of the present disclosure. As illustrated in FIG. 11, on a dielectric substrate 902, a plurality of array antennas 901a to 901h where a plurality of radiating elements 903 are arrayed in the Y direction are arrayed in the X direction. On the back face of the dielectric substrate 902, a ground plate 905 is provided.

Each radiating element 903 is coupled to a radio unit 906 through corresponding one of feeding lines 904a to 904h. The shape of each radiating element 903 is rectangular and all the radiating elements 903 are excited in phase by setting the length of each radiating element 903 in the long-length direction to 0.5 λe. The long-length direction of each radiating element 903 matches the polarization direction of the radiating element 903. Thus, as illustrated in FIG. 11, similar advantages to those brought in the example illustrated in FIG. 9 can be obtained by causing the rotation angles α for the radiating elements 903 in the long-length direction to be similar to the rotation angles in the example illustrated in FIG. 9.

Also, in the example illustrated in FIG. 11, the radiating elements arranged so as to be aligned in the X direction are arranged so that the positions of the coupling points to the feeding lines agree in the Y direction and are aligned at regular intervals in the X direction. In addition, the radiating elements arranged so as to be aligned in the X direction are arranged so that the respective central positions of the radiating elements in the X direction and the Y direction agree in the Y direction and are aligned at regular intervals in the X direction. The radiating elements may be arranged so that the central positions thereof in the X direction or the Y direction are spaced at non-regular intervals in the X direction.

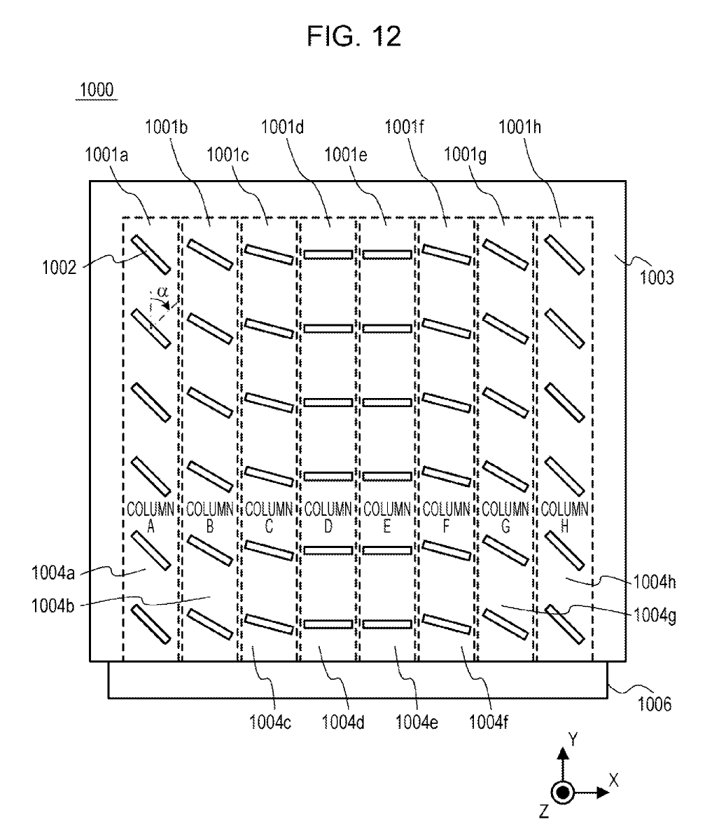

FIG. 12 illustrates an example of a planar array antenna 1000, where a configuration according to the present disclosure is implemented with a slot array antenna. In the planar array antenna 1000, array antennas 1001a to 1001h in respective columns are arrayed in the X direction and part of a metal plate 1003 is provided with slots 1002 that function as radiating elements.

The radiating elements are electrically coupled to a radio unit 1006 through waveguides 1004a to 1004h. When λg represents each intra-pipe wavelength of the waveguides 1004a to 1004h, all the radiating elements are excited in phase by setting the length of each slot 1002 in the long-length direction to λg. Further, the short-length direction of each slot 1002 matches the polarization direction of each radiating element. Thus, as illustrated in FIG. 12, similar advantages to those brought in the example illustrated in FIG. 9 can be obtained by causing the rotation angles α for the slots 1002 in the short-length direction to be similar to the rotation angles in the example illustrated in FIG. 9.

Moreover, although in the example illustrated in FIG. 12, the radiating elements arranged so as to be aligned in the X direction are arranged so that the respective central positions of the radiating elements in the X direction and the Y direction agree in the Y direction and are spaced at regular intervals in the X direction. The respective central positions of the radiating elements in the X direction or the Y direction may be arranged at non-regular intervals in the X direction.

### Fifth Embodiment

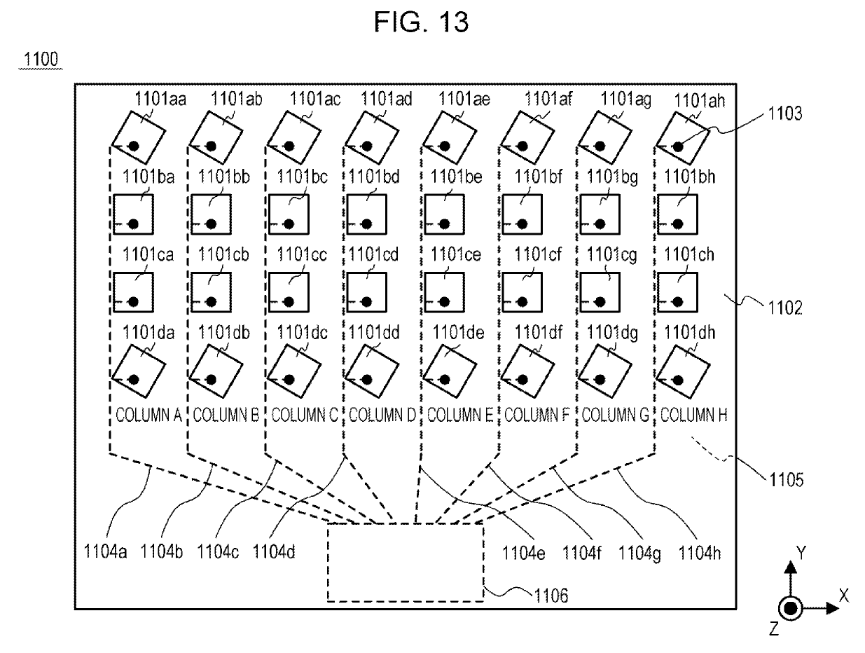

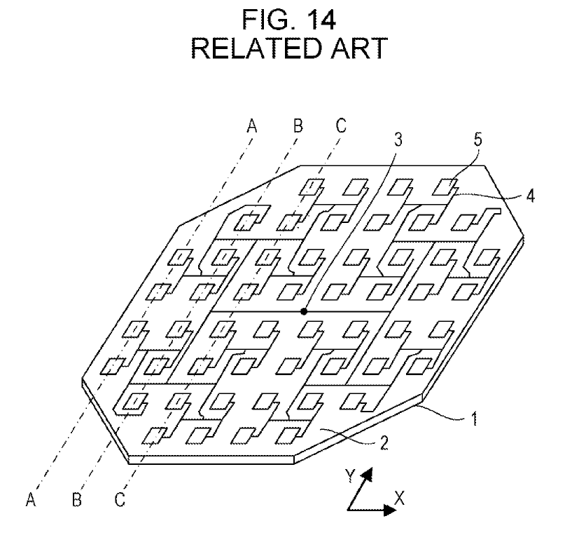

FIG. 13 is a plan view that illustrates a configuration of a planar array antenna 1100 according to a fifth embodiment of the present disclosure. Since the basic configuration of the planar array antenna 1100 according to the fifth embodiment is similar to the configuration of the planar array antenna 700 according to the fourth embodiment, the description thereof may be omitted.

In the planar array antenna 700 according to the fourth embodiment, the rotation angles of the radiating elements are changed on a column-by-column basis. That is, the rotation angles α for the radiating elements in columns A and H are each set to 45 degrees, the rotation angles α for the radiating elements in columns B and G are each set to 30 degrees, and the rotation angles α for the radiating elements in columns C and F are each set to 15 degrees.

In contrast, in the fifth embodiment illustrated in FIG. 13, among the radiating elements in respective columns, the rotation angles α for radiating elements 1101ba to 1101bh and 1101ca to 1101ch, which are positioned closer to a central portion in the Y direction, are each set to 0 degrees and the rotation angles α for radiating elements 1101aa to 1101ah, which are positioned on an end portion side in the +Y direction, and for radiating elements 1101da to 1101dh, which are positioned on an end portion side in the −Y direction, are each set to 30 degrees.

Such an arrangement enables side lobes in a YZ-plane radiation pattern of the planar array antenna 1100 to be reduced.

Although each embodiment of the present disclosure is described above, the present disclosure is not limited to the descriptions of the embodiments. It is also possible to combine the embodiments as appropriate.

The array antenna according to the present disclosure is applicable to a radar device installed in a vehicle for example.

What is claimed is:

1. An array antenna comprising:
a dielectric substrate; and
a plurality of radiating elements being arranged linearly and provided on a first face of the dielectric substrate, each of the plurality of radiating elements having linear polarization and a rotation reference point, wherein
one or more radiating elements included in the plurality of radiating elements are rotated differently with respect to the corresponding rotation reference positions each other.

2. The array antenna according to claim 1, wherein
the plurality of radiating elements include a first radiating element and a second radiating element, the second radiating element being adjacent to the first radiating element in a portion close to a center of the array antenna,
deviation of a polarization direction of the first radiating element from a main polarization direction is larger than deviation of a polarization direction of the second radiating element from the main polarization direction, the main polarization direction being determined by a configuration applied with the plurality of radiating elements, and
one or more polarization directions corresponding to the one or more radiating elements is different from polarization directions of other radiating elements included in the plurality of radiating elements.

3. The array antenna according to claim 1, wherein
a plurality of radiating element groups are arrayed, each of the plurality of radiating element groups including the plurality of radiating elements.

4. The array antenna according to claim 1, wherein
each of the plurality of radiating elements includes a center coordinate,
each of the plurality of rotation reference points coincides with the corresponding center coordinate, and
the plurality of rotation reference points are arranged linearly.

5. The array antenna according to claim 1, wherein
each of the plurality of radiating elements includes a feeding point,
each of the plurality of rotation reference points coincides with the corresponding feeding point, and
the plurality of rotation reference points are arranged linearly.

6. The array antenna according to claim 1, wherein
the array antenna is one of a loop array antenna, a slot array antenna, a patch array antenna, and a micro-strip comb-line antenna.
